(19) United States
(12) Patent Application Publication
(10) Pub. No.: US 2025/0039072 A1
(43) Pub. Date: Jan. 30, 2025

(54) COMMUNICATION DEVICE, COMMUNICATION SYSTEM, METHOD FOR SPECIFYING PACKET LOSS, AND NON-TRANSITORY COMPUTER READABLE STORAGE MEDIUM

(71) Applicant: DENSO CORPORATION, Kariya-city (JP)

(72) Inventor: Tsuneo NAKATA, Kariya-city (JP)

(21) Appl. No.: 18/776,299

(22) Filed: Jul. 18, 2024

(30) Foreign Application Priority Data
Jul. 27, 2023 (JP) 2023-122449

(51) Int. Cl. H04L 43/0829; H04L 1/08

(52) U.S. Cl. CPC H04L 43/0829; H04L 1/08

(57) ABSTRACT

A packet loss is specified in a communication device for transmitting a communication packet to a destination device via a route and receiving a delivery confirmation packet of the communication packet from the destination device. Sequence information of the communication packet for a communication flow is acquired. A correspondence relationship between a transmission order of the communication packet and the sequence information of the communication packet for each route is stored as transmission order correspondence information. Delivery confirmation information indicating a delivery state of the communication packet is acquired. It is determined whether the packet loss has occurred based on the transmission order correspondence information and the delivery confirmation information.

### CROSS REFERENCE TO RELATED APPLICATION

The present application claims the benefit of priority from Japanese Patent Application No. 2023-122449 filed on Jul. 27, 2023. The entire disclosure of the above application is incorporated herein by reference.

### TECHNICAL FIELD

The present disclosure relates to a communication device, a communication system, a method for specifying a packet loss, and a non-transitory computer readable storage medium.

### BACKGROUND

In packet communication, a communication device transmits a communication packet to a destination device, and upon receiving the communication packet from the communication device, the destination device transmits a reception confirmation packet for the communication packet to the communication device. For example, a conceivable technique teaches a technique such that, when a communication device transmits a communication packet to a destination device using a plurality of routes, sequence information for each route and sequence information of the communication packet for each communication flow are added to the communication packet to determine whether a packet loss has occurred based on the sequence information for each route.

### SUMMARY

According to an example, a packet loss is specified in a communication device for transmitting a communication packet to a destination device via a route and receiving a delivery confirmation packet of the communication packet from the destination device. Sequence information of the communication packet for a communication flow is acquired. A correspondence relationship between a transmission order of the communication packet and the sequence information of the communication packet for each route is stored as transmission order correspondence information. Delivery confirmation information indicating a delivery state of the communication packet is acquired. It is determined whether the packet loss has occurred based on the transmission order correspondence information and the delivery confirmation information.

### BRIEF DESCRIPTION OF THE DRAWINGS

The above and other objects, features and advantages of the present disclosure will become more apparent from the following detailed description made with reference to the accompanying drawings. In the drawings:

FIG. 1 is a functional block diagram illustrating an overall configuration of a first embodiment;

FIG. 2 is a flowchart showing a determination process of a packet loss;

FIG. 3 is a diagram explaining the occurrence of the packet loss;

FIG. 4 is a diagram explaining delivery confirmation information;

FIG. 5 is a diagram showing the second embodiment and explaining the occurrence of packet loss;

FIG. 6 is a diagram explaining the delivery confirmation information;

FIG. 7 is a functional block diagram illustrating an overall configuration of a third embodiment;

FIG. 8 is a flowchart showing a determination process of a packet loss;

FIG. 9 is a diagram explaining the occurrence of the packet loss;

FIG. 10 is a diagram explaining delivery confirmation information;

FIG. 11 is a functional block diagram illustrating an overall configuration of a fourth embodiment;

FIG. 12 is a flowchart showing a determination process of a packet loss;

FIG. 13 is a diagram explaining the occurrence of the packet loss;

FIG. 14 is a diagram explaining the delivery confirmation information;

FIG. 15 is a functional block diagram illustrating an overall configuration of a fifth embodiment;

FIG. 16 is a diagram explaining the occurrence of the packet loss; and

FIG. 17 is a diagram explaining the delivery confirmation information.

### DETAILED DESCRIPTION

In the method according to the conceivable technique, it is necessary to provide sequence information for each route and sequence information of a communication packet for each communication flow in order to determine whether or not a packet loss has occurred. Therefore, since two types of sequence information are provided, there is a difficulty that the load associated with preprocessing to specify the occurrence of the packet loss may be large.

The present embodiments have been made in view of the above-described circumstances, and an object of the present embodiments is to provide a communication device, a communication system, a method for specifying a packet loss, and a program for specifying a packet loss which provide to appropriately specify an occurrence of a packet loss while restricting a load related to preprocessing for specifying an occurrence of a packet loss.

According to the first aspect of the present embodiments, a communication packet is transmitted to a destination device using a plurality of routes, and a delivery confirmation packet with respect to the communication packet is received from the destination device. A sequence information acquisition unit acquires sequence information of the communication packet of a communication flow. A transmission order correspondence information storage unit stores a correspondence relationship between a transmission order of the communication packet and the sequence information of the communication packet acquired by the sequence information acquisition unit for each route as transmission order correspondence information. A delivery confirmation information acquisition unit acquires the delivery confirmation information indicating the delivery state of the communication packet. A packet loss determination unit determines whether or not a packet loss has occurred based on the transmission order correspondence information stored in the transmission order correspondence information storage unit and the delivery confirmation information acquired by the delivery confirmation information acquisition unit.

Thus, the correspondence relationship between the transmission order of the communication packet and the sequence information of the communication packet for each route is stored as the transmission order correspondence information, and the occurrence of the packet loss is determined based on the stored transmission order correspondence information and the delivery confirmation information indicating the delivery state of the communication packet. There is no need to provide two types of sequence information, i.e., the sequence information for each route and the sequence information of the communication packet for each communication flow, and it is possible to specify the occurrence of the packet loss. Thereby, the occurrence of the packet loss can be appropriately specified while restricting the load related to the preprocessing for specifying the occurrence of the packet loss.

The following will describe embodiments of the present disclosure with reference to the accompanying drawings. In the subsequent embodiment, description of the same content as the preceding embodiment may be omitted.

### First Embodiment

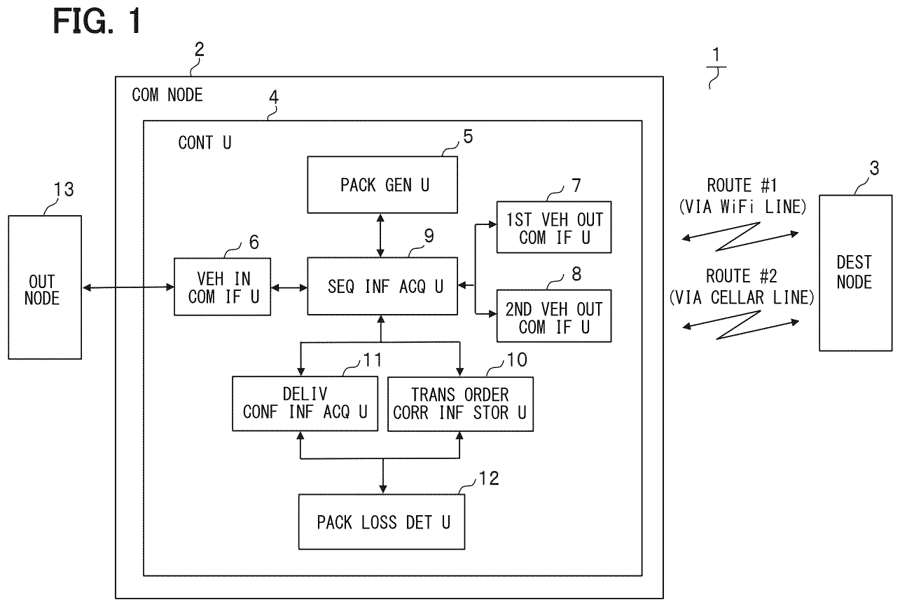

The first embodiment will be described with reference to FIG. 1 to FIG. 4. As shown in FIG. 1, a communication system 1 is configured to be capable of communicating data between a communication node 2 (corresponding to a communication device) and a destination node 3 (corresponding to a destination device) via a wireless line. The data communication performed between the communication node 2 and the destination node 3 is based on the TCP/IP (i.e., Transmission Control Protocol/Internet Protocol) communication protocol. The communication node 2 transmits a communication packet to the destination node 3 via a wireless link. When the destination node 3 receives a communication packet from the communication node 2, the destination node 3 transmits a delivery confirmation packet in response to the received communication packet to the communication node 2 via a wireless line. Here, the communication node 2 and the destination node 3 may be configured to be able to communicate data via a base station, and the communication node 2 and the base station may perform data communication via a wireless line, and the destination node 3 and the base station may perform data communication via a wired line.

The communication node 2 includes a control unit 4 that controls the operation of the entire nodes. The control unit 4 is provided by a microcomputer having a CPU (i.e., Central Process Unit), a ROM (i.e., Read Only Memory), a RAM (i.e., Random Access Memory), and an I-O (i.e., Input-Output). A function provided by the control unit 4 can be provided by software stored in a tangible memory device and a computer that executes the software, only software, only hardware, or a combination thereof. For example, when the control unit 4 is provided by an electronic circuit that is hardware, the control unit 4 can be provided by a digital circuit including a large number of logic circuits or an analog circuit. When the control unit 4 executes the program stored in the non-transitory tangible storage medium, a process corresponding to the program is executed, and a method corresponding to the program is executed.

The control unit 4 includes, for each function, a packet generation unit 5, a vehicle inside communication interface unit 6 (corresponding to a packet reception unit), a first vehicle outside communication interface unit 7, a second outside communication interface unit 8, a sequence information acquisition unit 9, a transmission order correspondence information storage unit 10, a delivery confirmation information acquisition unit 11, and a packet loss determination unit 12. Each of these units 5 to 12 executes a program for specifying a packet loss and performs a method for specifying a packet loss.

The packet generation unit 5 generates a communication packet according to the execution of the application by the control unit 4, and outputs the generated communication packet to the sequence information acquisition unit 9. When the vehicle inside communication interface unit 6 receives a communication packet from the outside node 13 (corresponding to an outside device), the vehicle inside communication interface unit 6 outputs the received communication packet to the sequence information acquisition unit 9.

The first vehicle outside communication interface unit 7 performs data communication conforming to the communication protocol of, for example, a WiFi (registered trademark) line as a route 1, transmits a communication packet to a destination node 3 via the WiFi line, and receives a delivery confirmation packet in response to the communication packet from the destination node 3 via the WiFi line. The second vehicle outside communication interface unit 8 performs data communication conforming to a communication protocol of a cellular line as a route 2, transmits a communication packet to the destination node 3 via the cellular line, and transmits a delivery confirmation packet in response to the communication packet from the destination node 3 via the cellular line. Here, the combination of the route 1 and the route 2 is not limited to a combination of a WiFi line and a cellular line, but may be a combination of lines with different communication protocols.

When two routes, i.e., the route 1 and the route 2, are prepared as transmission routes for the communication packet, the transmission order of the communication packet from the communication node 2 may be different from the reception order of the communication packet to the destination node 3 due to the difference in line delay depending on the communication state between the routes. In other words, if the communication state of the route 1 is relatively good and the communication state of the route 2 is relatively poor, a case may occur such that the communication packet later transmitted from the communication node 2 to the route 1 is received by the destination node 3 earlier than the communication packet earlier transmitted from the communication node 2 to the route 2 is received by the destination node 3. Conversely, if the communication state of the route 1 is relatively poor and the communication state of the route 2 is relatively good, a case may occur such that the communication packet later transmitted from the communication node 2 to the route 2 is received by the destination node 3 earlier than the communication packet earlier transmitted from the communication node 2 to the route 1 is received by the destination node 3.

The sequence information acquisition unit 9 acquires sequence numbers (corresponding to sequence information) of the communication packet and the delivery confirmation packet for which processing has been scheduled in advance. The sequence number is information capable of specifying the transmission order of the communication packet and the reception order of the delivery confirmation packet, respectively. As long as it is possible to specify the transmission order of the communication packet and the reception order of the delivery confirmation packet, information other than the sequence number may be used instead of the sequence number.

When the sequence number of a communication packet is acquired by the sequence information acquisition unit 9, the transmission order correspondence information storage unit 10 stores the correspondence relationship between the transmission order of the communication packet for each route and the acquired sequence number of the communication packet as a transmission order correspondence table (corresponding to transmission order correspondence information).

The delivery confirmation information acquisition unit 11 acquires delivery confirmation information indicating the delivery state of the communication packet using the delivery confirmation packet. When delivery confirmation information is acquired by the delivery confirmation information acquisition unit 11, the packet loss determination unit 12 determines whether or not a packet loss has occurred based on the transmission order correspondence table stored in the transmission order correspondence information storage unit 10 and the acquired delivery confirmation information. That is, the packet loss determination unit 12 determines whether the delivery confirmation information matches the transmission order correspondence table. If the packet loss determination unit 12 determines that the delivery confirmation information matches the transmission order correspondence table, the packet loss determination unit 12 determines that no packet loss has occurred. On the other hand, when the packet loss determination unit 12 determines that the delivery confirmation information does not match the transmission order correspondence table, the packet loss determination unit 12 determines that a packet loss has occurred.

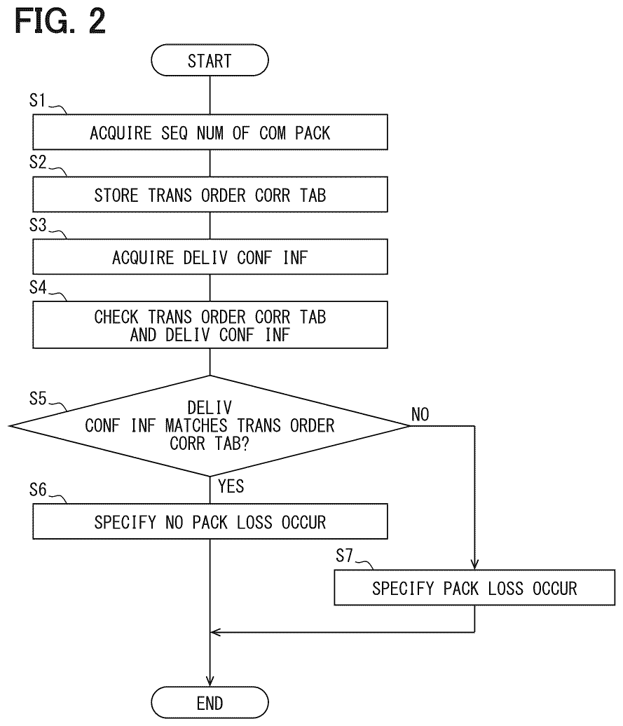

Next, the process of the above configuration will be described with reference to FIGS. 2 to 4. When a communication packet transmission request is generated, the control unit 4 executes a communication packet transmission process to transmit the communication packet with respect to the transmission request to the destination node 3, and executes a determination process of the packet loss for determining whether or not a loss of the communication packet of the transmission request has occurred.

When the control unit 4 starts the packet loss determination process, the control unit 4 acquires the sequence number of the communication packet that is the target of the transmission request (at S1, which corresponds to the sequence information acquisition procedure). When the control unit 4 transmits the communication packet to the destination node 3, the control unit 4 stores the correspondence relationship between the sequence number of the acquired communication packet and the transmission order on the route used to transmit the communication packet as a transmission order correspondence table (at S2, corresponds to the transmission order correspondence information storage procedure).

When the destination node 3 receives a communication packet from the communication node 2, the destination node 3 transmits to the communication node 2 a delivery confirmation packet for the received communication packet, and also transmits to the communication node 2 delivery confirmation information indicating the delivery state of the communication packet.

When the control unit 4 receives a delivery confirmation packet and the delivery confirmation information from the destination node 3, the control unit 4 acquires the sequence number of the received delivery confirmation packet and acquires the delivery confirmation information (at S3, which corresponds to the delivery confirmation information acquisition procedure). The control unit 4 checks the acquired delivery confirmation information with the transmission order correspondence table (at S4), and determines whether the delivery confirmation information matches the transmission order correspondence table (at S5, which corresponds to the packet loss determination procedure).

If the control unit 4 determines that the delivery confirmation information matches the transmission order correspondence table (“YES” at S5), the control unit 4 specifies that no packet loss has occurred (at S6), and ends the packet loss determination process. On the other hand, if the control unit 4 determines that the delivery confirmation information does not match the transmission order correspondence table (“NO” at S5), the control unit 4 specifies that a packet loss has occurred (at S7), and ends the packet loss determination process.

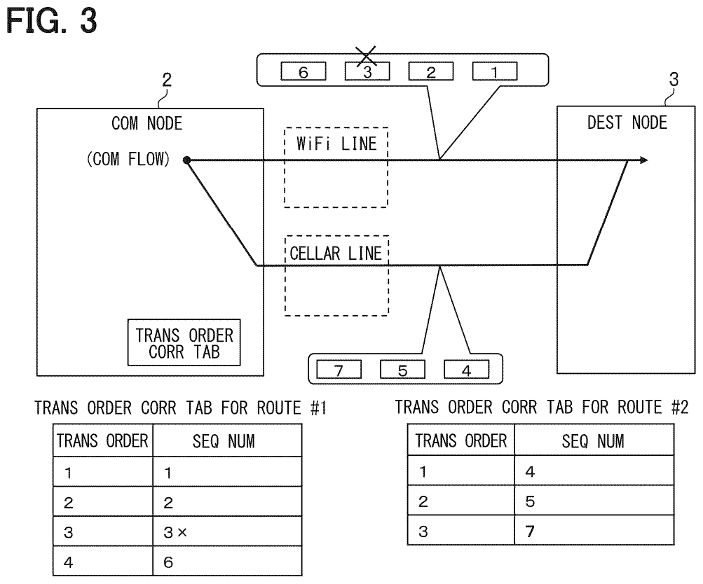

As shown in FIG. 3, a example case is explained such that the communication node 2 transmits communication packets with sequence numbers “1” to “3” and “6” to the destination node 3 via the route 1, and transmits communication packets with sequence numbers “4” to “5” and “7” to the destination node 3 via the route 2. In this case, the communication node 2 associates the transmission order of “1” to “4” with the sequence numbers “1” to “3” and “6” in the transmission order correspondence table for the route 1, and associates the transmission order of “1” to “3” with the sequence numbers “4” to “5” and “7” in the transmission order correspondence table for the route 2.

The communication node 2 transmits the communication packets to the destination node 3 in the order of sequence numbers “1” to “7”, but as described above, due to the difference in line delay depending on the communication state between the routes, the transmission order of the communication packets from the communication node 2 may be different from the reception order of the communication packets to the destination node 3. For example, if the communication state of the route 1 is relatively good and the communication state of the route 2 is relatively poor, a communication packet with the sequence number of “6” may be received by the destination node 6 earlier than a communication packet with the sequence number of “4”. When the destination node 3 receives the communication packet with the sequence number of “6” earlier than the communication packet with the sequence number of “4”, the destination node 3 transmits the delivery confirmation packet for the communication packet with the sequence number of “6” to the communication node 2 before the destination node 3 transmits the delivery confirmation packet for the communication packet with the sequence number of “4” to the communication node 2.

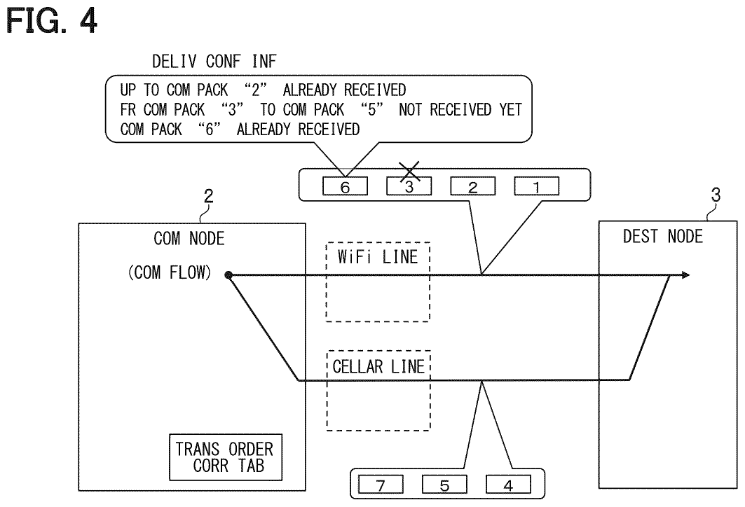

In this case, as shown in FIG. 4, the destination node 3 transmits a delivery confirmation packet for the communication packet with the sequence number “6” to the communication node 2, and also transmits to the communication node 2 the delivery confirmation information indicating that the communication packets up to the sequence number of “2” have been received, the communication packets with the sequence numbers “3” to “5” have not been received, and the communication packet with the sequence number of “6” has been received.

When the communication node 2 receives the delivery confirmation packet for the communication packet with the sequence number of “6” from the destination node 3 and also receives the delivery confirmation information, the communication node 2 specifies that the communication packets with the sequence numbers “3” to “5” have not been received, based on the received delivery confirmation information. Here, the communication node 2 does not specify the communication packets with the sequence numbers “4” to “5” as a loss since the communication packets with the sequence numbers “4” to “5” are transmitted via a route different from the communication packet with the sequence number of “6”. On the other hand, the communication node 2 specifies the communication packet with the sequence number of “3” as loss since the communication packet with the sequence number of “3” is transmitted via the same route as the communication packet with the sequence number of “6”.

In other words, in the above-described situation, in a configuration in which the loss is determined solely based on the order of sequence numbers, retransmission process of the communication packets with the sequence numbers of “4” to “5” that are not originally needed occurs since it is specified that the loss of the communication packets with the sequence numbers “3” to “5” has occurred. On the other hand, in this embodiment, retransmission process of the communication packets with the sequence numbers of “4” to “5” is not executed since it is specified that only the loss of the communication packet with the sequence numbers of “3” has occurred. By using the transmission order correspondence table, it is possible to avoid unnecessary redundant retransmission without transmitting the sequence number for each communication flow to the destination node 3.

The above-described first embodiment provides following operational effects. In the communication node 2, it is determined whether the packet loss has occurred, based on the transmission order correspondence table that shows the correspondence relationship between the transmission order of the communication packets and the sequence numbers of communication packets for each route, and the delivery confirmation information that shows the delivery state of the communication packets. There is no need to provide two types of sequence information, i.e., the sequence information for each route and the sequence information of the communication packet for each communication flow, and it is possible to specify the occurrence of the packet loss. Thereby, the occurrence of the packet loss can be appropriately specified while restricting the load related to the preprocessing for specifying the occurrence of the packet loss.

It is determined whether a packet loss has occurred in a communication packet generated by the communication node 2. The communication packet generated by the communication node 2 is defined as the target, and the occurrence of the packet loss can be appropriately specified.

It is determined whether or not a packet loss has occurred with respect to a communication packet received from an outside node 13. The communication packet received from the outside node 13 is defined as the target, and the occurrence of the packet loss can be appropriately specified.

### Second Embodiment

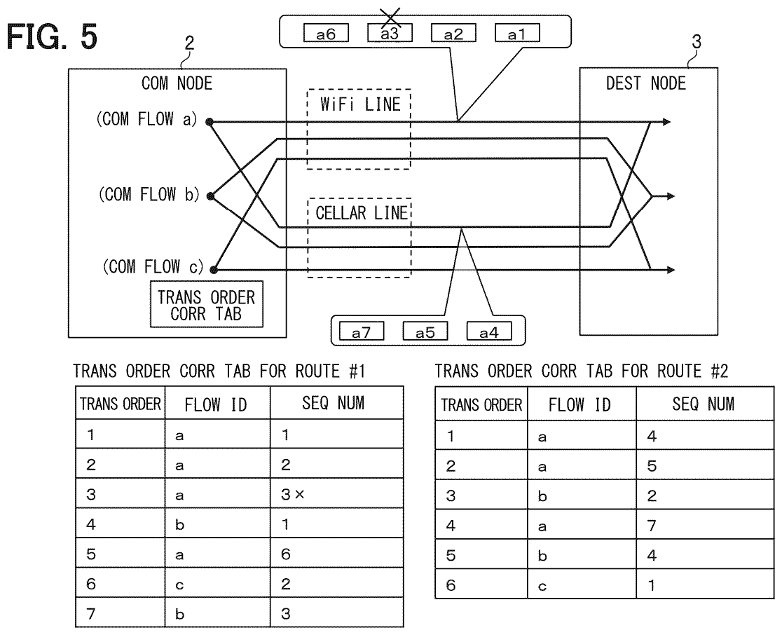

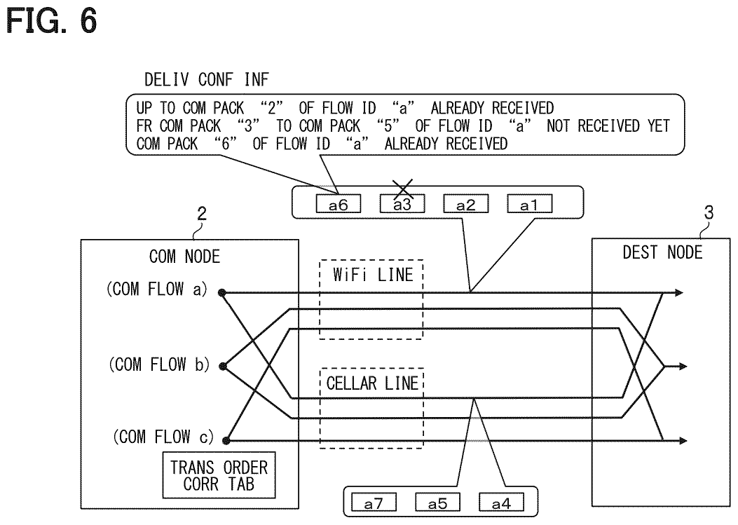

The second embodiment will be described with reference to FIG. 5 to FIG. 6. While the first embodiment has a configuration that one communication flow is the target, the second embodiment has a configuration that multiple communication flows are targets. The transmission order correspondence information storage unit 10 stores the correspondence relationship between the transmission order of communication packets for each route, a flow ID (corresponding to flow identification information) that identifies the communication flow, and the sequence number of the communication packet as a transmission order correspondence table (corresponding to transmission order correspondence information).

As shown in FIG. 5, an example case will be explained such that communication flows “a” to “c” at the communication node 2 are targets, the communication packets with the sequence numbers “1” to “3”, and “6” are transmitted to the destination node 3 via the route 1 for the communication flow “a”, and the communication packets with the sequence numbers “4” to “5”, and “7” are transmitted to the destination node 3 via the route 2 for the communication flow “a”. In this case, the communication node 2 associates the transmission order “1” to “3” and “5” with the sequence numbers “1” to “3” and “6” for the flow ID “a”, and associates the transmission orders “1” to “2” and “4” with the sequence numbers “4” to “5” and “7” for the flow ID “a”, as the transmission order correspondence table.

When the destination node 3 receives a communication packet with the sequence number “6” of the flow ID “a” before receiving the communication packet with the sequence number “4” of flow ID “a”, the destination node 3 transmits a delivery confirmation packet for the communication packet with the sequence number “6” of the flow ID “a” to the communication node 2 before transmitting a delivery confirmation packet for the communication packet with the sequence number “4” of flow ID “a” to the communication node 2.

As shown in FIG. 6, the destination node 3 transmits a delivery confirmation packet for the communication packet with the sequence number “6” of the flow ID “a” to the communication node 2, and also transmits the delivery confirmation information to the communication node 2 indicating that “the communication packets up to the sequence number of “2” of the flow ID “a” have been received, the communication packets with the sequence numbers “3” to “5” of the flow ID “a” have not been received, and the communication packet with the sequence number of “6” of the flow ID “a” has been received.

When the communication node 2 receives a delivery confirmation packet for a communication packet with the sequence number “6” of the flow ID “a” from the destination node 3 and also receives the delivery confirmation information, the communication node 2 specifies based on the received delivery confirmation information that the communication packets with the sequence numbers “3” to “5” of the flow ID “a” have not been received. Here, the communication node 2 does not specify the communication packets with the sequence numbers “4” to “5” of the flow ID “a” as the loss since the communication packets with the sequence numbers “4” to “5” of the flow ID “a” are transmitted via a route different from the communication packet with the sequence number “6” of flow ID “a”. On the other hand, the communication node 2 specifies the communication packet with the sequence number “3” of the flow ID “a” as a loss since the communication packet with the sequence number “3” of the flow ID “a” is transmitted via the same route as the communication packet with the sequence number “6” of flow ID “a”.

Even in a configuration that multiple communication flows are targets, by using the transmission order correspondence table as in the first embodiment, unnecessary redundant retransmission can be avoided without transmitting the sequence numbers for each communication flow to the destination node 3. Although the above description is an example of the communication flow “a”, the same applies to the communication flow “b” and the communication flow “c”. The number of communication flows may not be limited to “3”.

The above-described second embodiment provides following operational effects. In the communication node 2, even in a configuration that a plurality of communication flows “a” to “c” are targets, the same effects as in the first embodiment can be obtained, and it is possible to appropriately specify the occurrence of the packet loss while restricting the load related to the preprocessing for specifying the occurrence of the packet loss.

### Third Embodiment

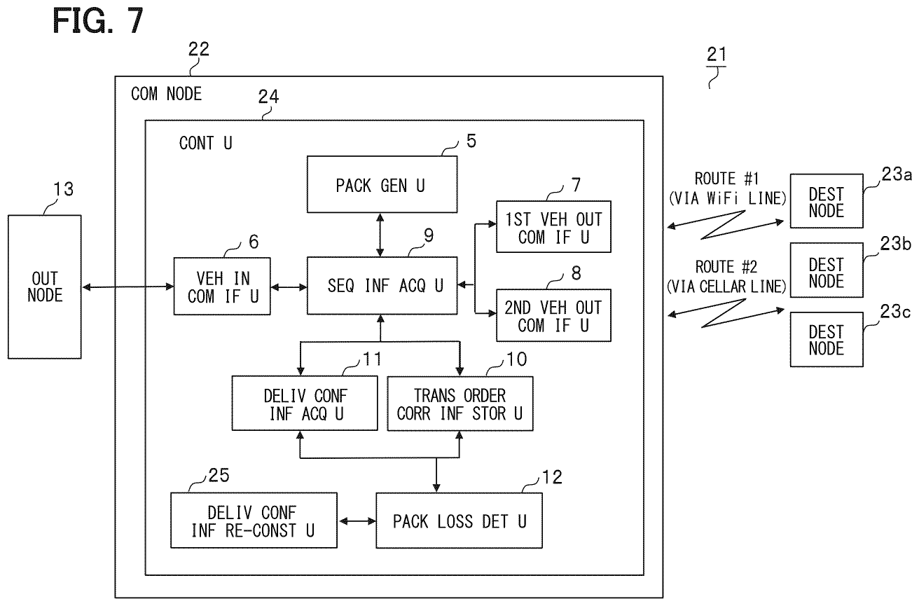

The third embodiment will be described with reference to FIG. 7 to FIG. 10. The third embodiment is configured such that a communication node functions as a relay node that transmits a communication packet received from a transmission node (corresponding to a transmission device) to a destination node.

As shown in FIG. 7, a communication system 21 is configured to be capable of communicating data between a communication node 22 (corresponding to a communication device) and destination nodes 23a to 23c (corresponding to a destination device) via a wireless line. In the communication node 22, the control unit 24 includes a packet generation unit 5, an vehicle inside communication interface unit 6, a first vehicle outside communication interface unit 7, a second vehicle outside communication interface unit 8, a sequence information acquisition unit 9, a transmission order correspondence information storage unit 10, a delivery confirmation information acquisition unit 11, and a packet loss determination unit 12, as well as a delivery confirmation information reconstruction unit 25. When the packet loss determination unit 12 specifies that a packet loss has occurred, the delivery confirmation information reconstruction unit 25 reconstructs the delivery confirmation information indicating the delivery state of the communication packet, and transmits the reconstructed delivery confirmation information to the transmission node.

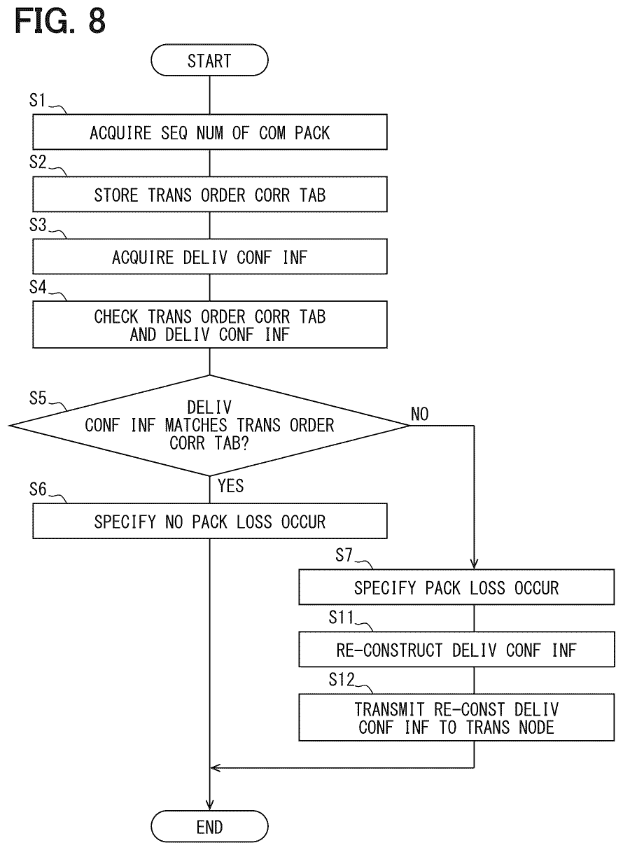

Next, the process of the above configuration will be described with reference to FIGS. 8 to 10.

The control unit 24 starts the packet loss determination process, performs S1 to S5 described in the first embodiment, and when it determines that the delivery confirmation information does not match the transmission order correspondence table (“NO” at S5) and it is specified that the packet loss has occurred (at S7), the control unit 24 reconstructs the delivery confirmation information indicating the delivery state of the communication packet (at S11), transmits the reconstructed delivery confirmation information to the transmission node (at S12), and ends the packet loss determination process.

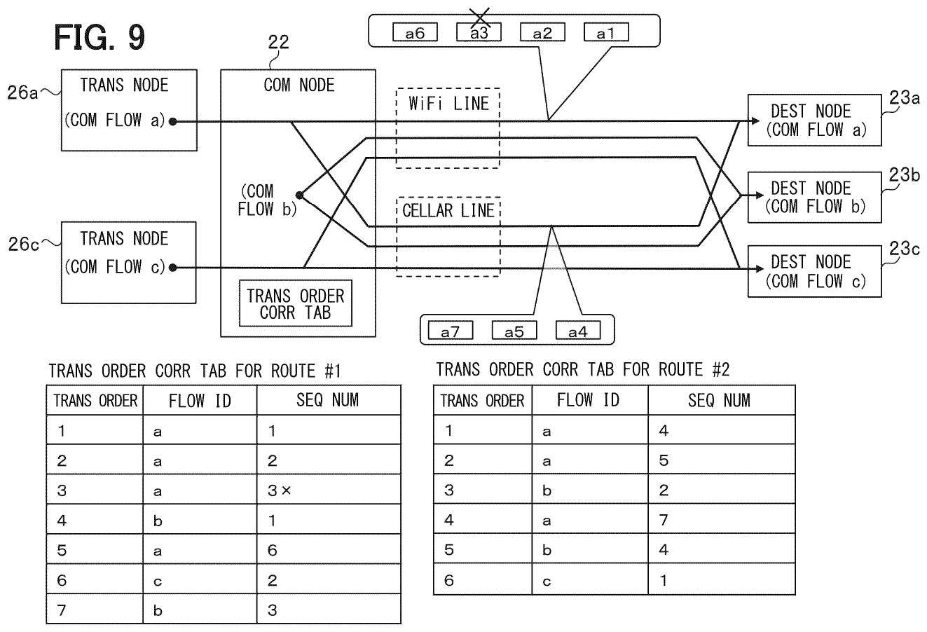

As shown in FIG. 9, in the communication node 22, an example case will be explained such that the communication flow “a” from the transmission node 26a is relayed and transmitted to the destination node 23a, the communication flow “b” is transmitted to the destination node 23b, and the communication flow “c” from the transmission node 26c is relayed and transmitted to the destination node 23c. The communication node 22 transmits the communication packets with the sequence numbers “1” to “3” and “6” to the destination node 23a via the route 1 for the communication flow “a”, and transmits the communication packets with the sequence numbers “4” to “5” and “7” to the destination node 23a via the route 2 for the communication flow “a”. In this case, similar to the second embodiment, the communication node 2 associates the transmission order “1” to “3” and “5” with the sequence numbers “1” to “3” and “6” for the flow ID “a”, and associates the transmission orders “1” to “2” and “4” with the sequence numbers “4” to “5” and “7” for the flow ID “a”, as the transmission order correspondence table.

When the destination node 23a receives a communication packet with the sequence number “6” of the flow ID “a” before receiving the communication packet with the sequence number “4” of flow ID “a”, the destination node 23a transmits a delivery confirmation packet for the communication packet with the sequence number “6” of the flow ID “a” to the communication node 22 before transmitting a delivery confirmation packet for the communication packet with the sequence number “4” of flow ID “a” to the communication node 22.

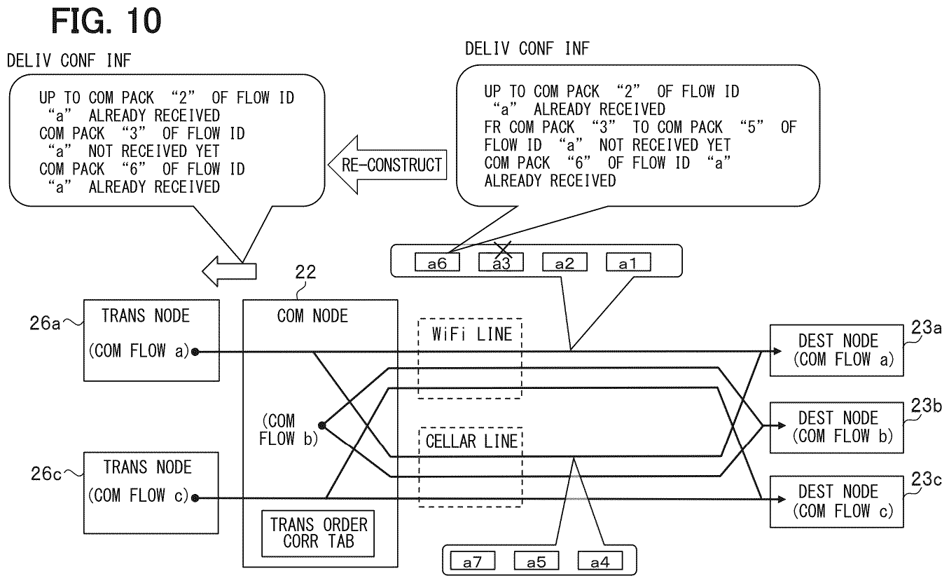

As shown in FIG. 10, the destination node 23a transmits a delivery confirmation packet for the communication packet with the sequence number “6” of the flow ID “a” to the communication node 22, and also transmits the delivery confirmation information to the communication node 22 indicating that the communication packets up to the sequence number of “2” of the flow ID “a” have been received, the communication packets with the sequence numbers “3” to “5” of the flow ID “a” have not been received, and the communication packet with the sequence number of “6” of the flow ID “a” has been received.

The communication node 22 receives a delivery confirmation packet for the communication packet with the sequence number “6” of the flow ID “a” from the destination node 23a, and upon receiving the delivery confirmation information, the communication node 22 specifies the loss of the communication packet with the sequence number “3” of the flow ID “a”. The communication node 22 reconstructs the received delivery confirmation information by changing the received delivery confirmation information to the information indicating that the communication packets up to the sequence number of “2” of the flow ID “a” have been received, the communication packet with the sequence number “3” of the flow ID “a” has not been received, and the communication packet with the sequence number of “6” of the flow ID “a” has been received. Then, the communication node 22 transmits the reconstructed delivery confirmation information to the transmission node 26a.

That is, if the delivery confirmation information received from the destination node 23a is transmitted to the transmission node 26a without being reconstructed, the transmission node 26a may specify that the communication packets with the sequence numbers “3” to “5” of the flow ID “a” are loss, and unnecessary redundant retransmission may occur. In this embodiment, the delivery confirmation information received from the destination node 23a is reconstructed and transmitted to the transmission node 26a, thereby it is possible to avoid unnecessary and redundant retransmission. Although the above description has been an example of the communication flow “a” from the transmission node 26a, the same applies to the communication flow “c” from the transmission node 26c.

The above-described third embodiment provides following operational effects. In the case where the communication node 22 functions as a relay node for transmitting the communication packets received from the transmission nodes 26a, 26c to the destination nodes 23a-23c, the delivery confirmation information received from the destination nodes 23a-23c is reconstructed and transmitted to the transmission nodes 26a, 26c, thereby it is possible to avoid unnecessary redundant retransmission from the transmission nodes 26a, 26c.

### Fourth Embodiment

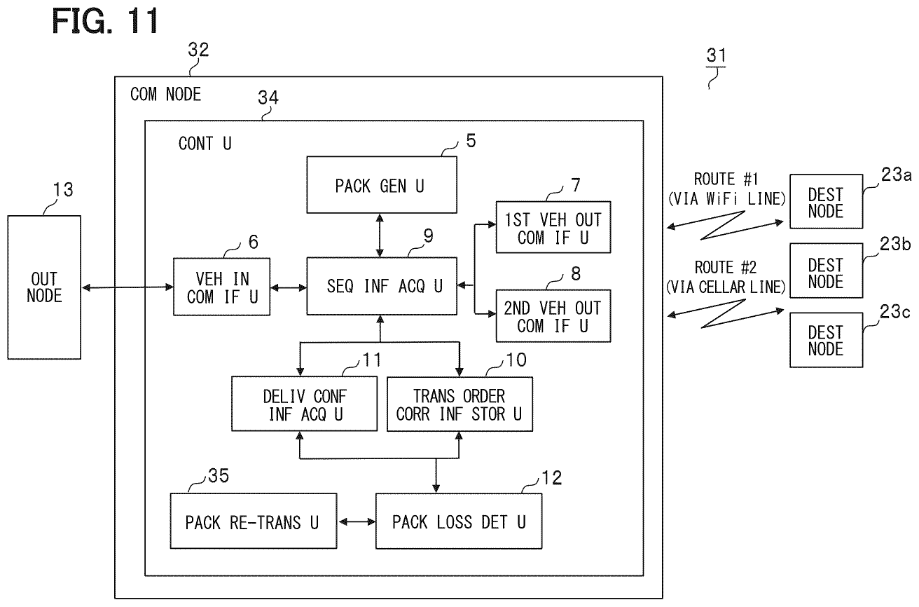

The fourth embodiment will be described with reference to FIG. 11 to FIG. 14. In the fourth embodiment, similarly to the third embodiment, a communication node functions as a relay node that transmits a communication packet received from a transmission node to a destination node.

As shown in FIG. 11, a communication system 31 is configured to be capable of communicating data between a communication node 32 (corresponding to a communication device) and destination nodes 23a to 23c (corresponding to a destination device) via a wireless line. In the communication node 32, the control unit 34 includes a packet generation unit 5, an vehicle inside communication interface unit 6, a first vehicle outside communication interface unit 7, a second vehicle outside communication interface unit 8, a sequence information acquisition unit 9, a transmission order correspondence information storage unit 10, a delivery confirmation information acquisition unit 11, and a packet loss determination unit 12, as well as a packet retransmission unit 35. When the packet loss determination unit 12 specifies that a packet loss has occurred, the packet retransmission unit 35 retransmits the communication packet in which the packet loss has been specified to the destination node.

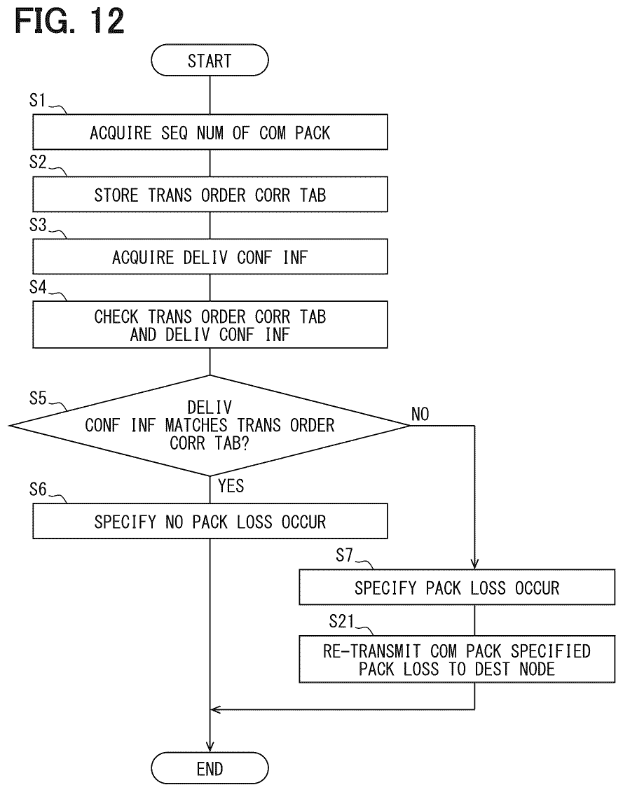

Next, the process of the above configuration will be described with reference to FIGS. 12 to 14.

The control unit 34 starts the packet loss determination process, performs S1 to S5 described in the first embodiment, and when it is determined that the delivery confirmation information does not match the transmission order correspondence table (“NO” at S5) and it is specified that the packet loss has occurred, the control unit 34 retransmits the communication packet in which the packet loss has been specified to the destination node (at S21), and ends the packet loss determination process.

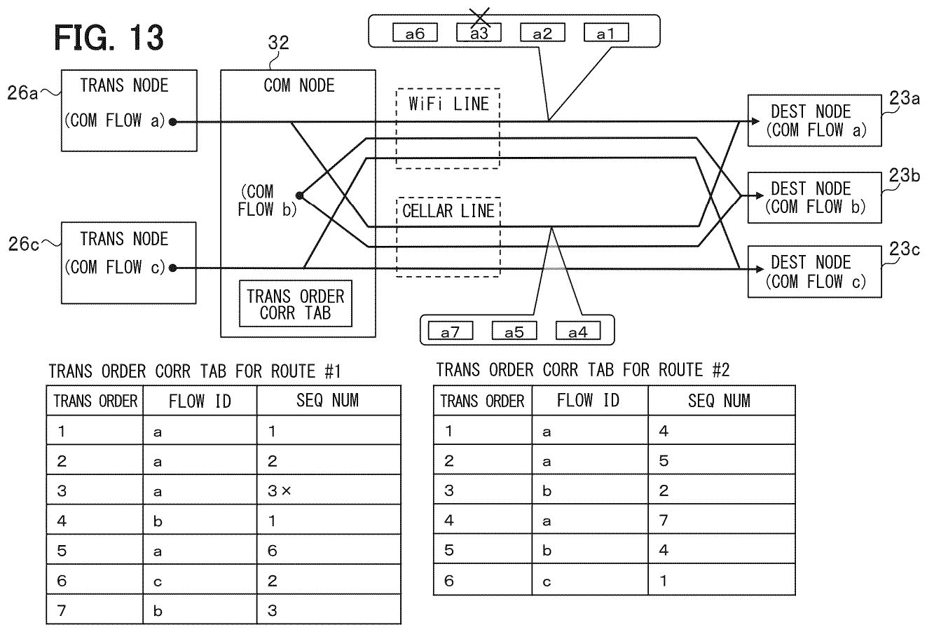

As shown in FIG. 13, similar to the third embodiment, in the communication node 32, an example case will be explained such that the communication flow “a” from the transmission node 26a is relayed and transmitted to the destination node 23a, the communication flow “b” is transmitted to the destination node 23b, and the communication flow “c” from the transmission node 26c is relayed and transmitted to the destination node 23c. A buffer that stores the communication packets received from the transmission nodes 26a and 26c is provided, and even after the communication packets are transmitted to the destination nodes 23a to 26c, the communication packets as a transmission target are stored in the buffer.

The communication node 32 transmits the communication packets with the sequence numbers “1” to “3” and “6” to the destination node 23a via the route 1 for the communication flow “a”, and transmits the communication packets with the sequence numbers “4” to “5” and “7” to the destination node 23a via the route 2 for the communication flow “a”. In this case, similar to the second embodiment, the communication node 32 associates the transmission order “1” to “3” and “5” with the sequence numbers “1” to “3” and “6” for the flow ID “a”, and associates the transmission orders “1” to “2” and “4” with the sequence numbers “4” to “5” and “7” for the flow ID “a”, as the transmission order correspondence table.

When the destination node 23a receives a communication packet with the sequence number “6” of the flow ID “a” before receiving the communication packet with the sequence number “4” of flow ID “a”, the destination node 23a transmits a delivery confirmation packet for the communication packet with the sequence number “6” of the flow ID “a” to the communication node 32 before transmitting a delivery confirmation packet for the communication packet with the sequence number “4” of flow ID “a” to the communication node 32.

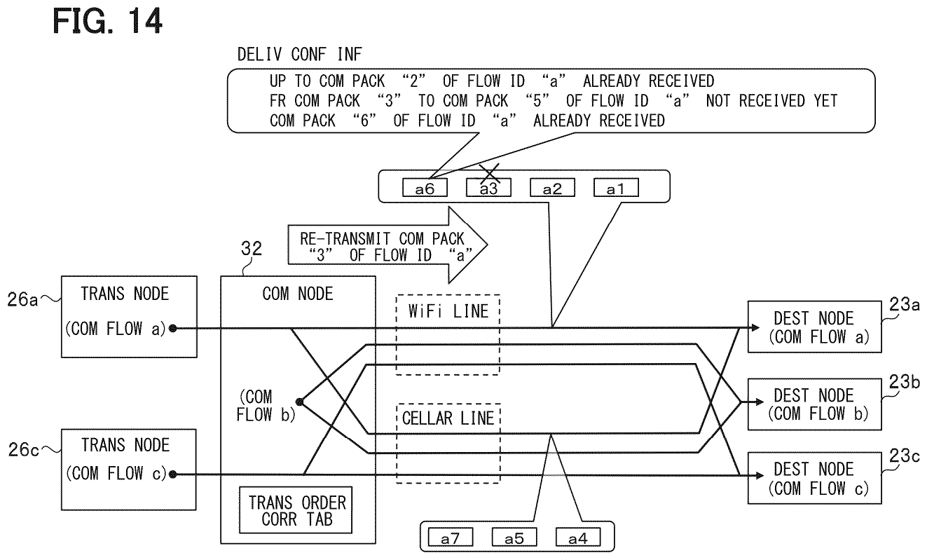

As shown in FIG. 14, the destination node 23a transmits a delivery confirmation packet for the communication packet with the sequence number “6” of the flow ID “a” to the communication node 32, and also transmits the delivery confirmation information to the communication node 32 indicating that the communication packets up to the sequence number of “2” of the flow ID “a” have been received, the communication packets with the sequence numbers “3” to “5” of the flow ID “a” have not been received, and the communication packet with the sequence number of “6” of the flow ID “a” has been received.

The communication node 32 receives a delivery confirmation packet for the communication packet with the sequence number “6” of the flow ID “a” from the destination node 23a, and upon receiving the delivery confirmation information, the communication node 32 specifies the loss of the communication packet with the sequence number “3” of the flow ID “a”. The communication node 32 retransmits the communication packet with the sequence number “3” of the flow ID “a” in which the packet loss has been specified to the destination node 23a.

That is, if the delivery confirmation information received from the destination node 23a is transmitted to the transmission node 26a as it is, the transmission node 26a may specify that the communication packets with the sequence numbers “3” to “5” of the flow ID “a” are loss, and unnecessary redundant retransmission may occur. In this embodiment, by retransmitting the communication packet with the sequence number “3” of the flow ID “a” in which the packet loss has been specified to the destination node 23a, unnecessary redundant retransmission can be avoided. Although the above description has been an example of the communication flow “a” from the transmission node 26a, the same applies to the communication flow “c” from the transmission node 26c.

The above-described fourth embodiment provides following operational effects. When the communication node 32 functions as a relay node that transmits the communication packets received from the transmission nodes 26a and 26c to the destination nodes 23a to 23c, by retransmitting the communication packets in which a packet loss has been specified to the destination node 23a, unnecessary redundant retransmission from the transmission nodes 26a and 26c can be avoided.

### Fifth Embodiment

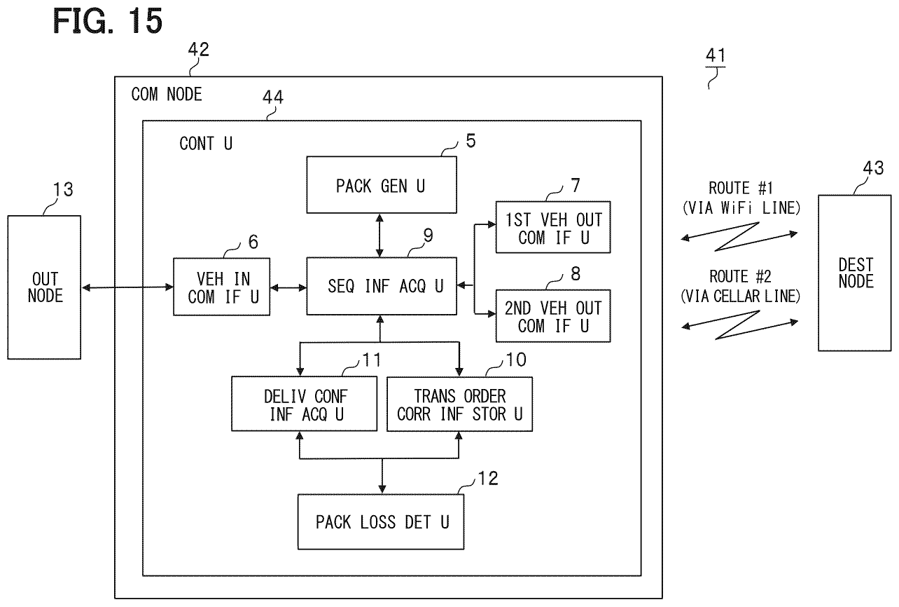

The fifth embodiment will be described with reference to FIG. 15 to FIG. 17. The fifth embodiment is configured such that the destination node transmits the delivery confirmation packet with thinning out data of the delivery confirmation packet.

As shown in FIG. 15, a communication system 41 is configured to be capable of communicating data between a communication node 42 (corresponding to a communication device) and a destination node 43 (corresponding to a destination device) via a wireless line. In the communication node 42, the control unit 44 has the same configuration as the control unit 4 described in the first embodiment. The destination node 43 determines whether the communication flows are the same and determines whether the sequence numbers are consecutive. The data of the delivery confirmation packet is thinned out and transmitted to the communication node 42 during a period in which the communication packets having the same communication flow and the consecutive sequence numbers are being received.

When the destination node 43 receives the communication packet with the sequence number “1” of the flow ID “a”, the destination node 43 transmits a delivery confirmation packet for the communication packet with the sequence number “1” of the flow ID “a” to the communication node 42. When the destination node 43 receives the communication packet with the sequence number “2” of the flow ID “a”, the destination node 43 does not transmit a delivery confirmation packet for the communication packet with sequence number “2” of the flow ID “a” to the communication node 42 since a condition is established such that the communication packets with the sequence number “1” of the flow ID “a” have the same communication flow and the consecutive sequence numbers.

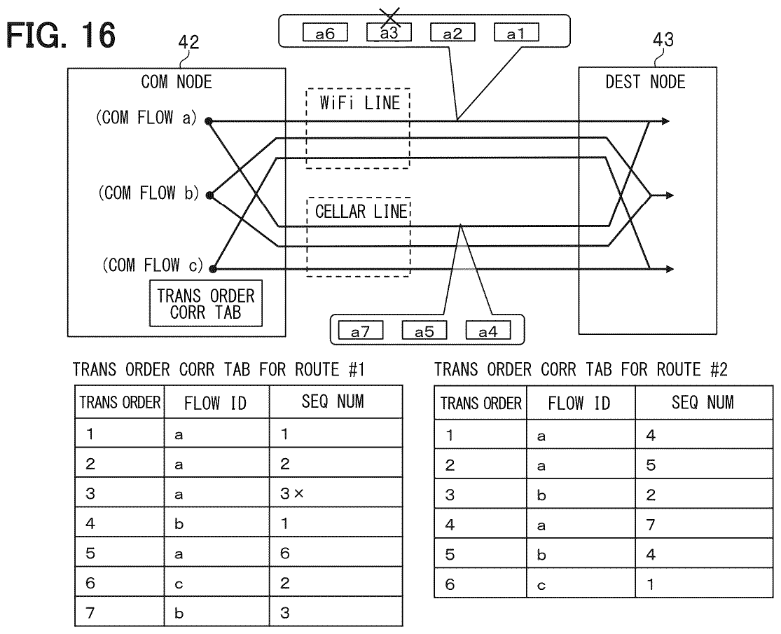

As shown in FIG. 16, a example case is explained such that the communication node 42 transmits the communication packets with the sequence numbers “1” to “3” and “6” to the destination node 23a via the route 1 for the flow ID “a”, and transmits communication packets with sequence numbers “4” to “5” and “7” to the destination node 23a via the route 2 for the flow ID “a”. In this case, similar to the second embodiment, the communication node 42 associates the transmission order “1” to “3” and “5” with the sequence numbers “1” to “3” and “6” for the flow ID “a”, and associates the transmission orders “1” to “2” and “4” with the sequence numbers “4” to “5” and “7” for the flow ID “a”, as the transmission order correspondence table.

When the destination node 43 receives a communication packet with the sequence number “6” of the flow ID “a” before receiving the communication packet with the sequence number “4” of flow ID “a”, the destination node 43 transmits a delivery confirmation packet for the communication packet with the sequence number “6” of the flow ID “a” to the communication node 42 before transmitting a delivery confirmation packet for the communication packet with the sequence number “4” of flow ID “a” to the communication node 42.

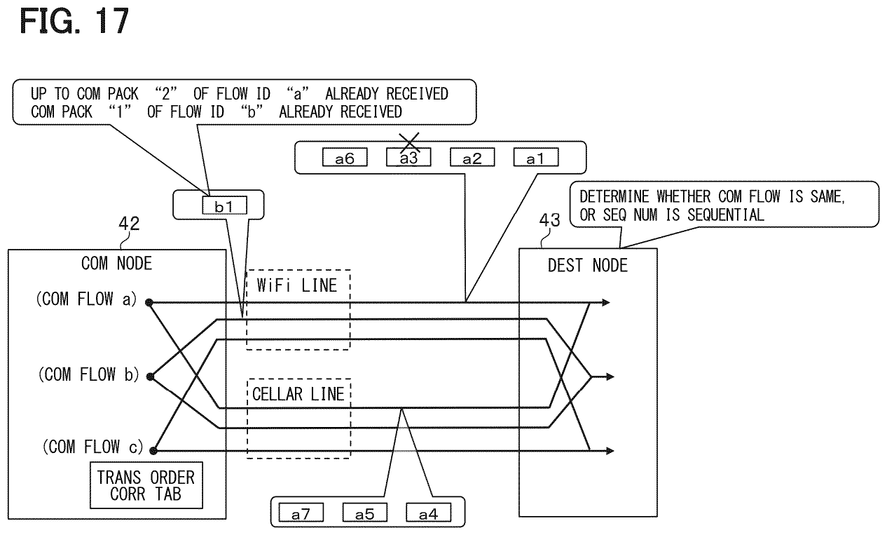

As shown in FIG. 17, when the destination node 43 receives the communication packet with the sequence number “1” of the flow ID “b”, the destination node 43 transmits a delivery confirmation packet for the communication packet with sequence number “1” of the flow ID “b” to the communication node 42 since a condition is not established such that the communication packets with the sequence number “2” of the flow ID “a” have the same communication flow and the consecutive sequence numbers. In this case, the destination node 43 transmits the delivery confirmation information to the communication node 42 indicating that the communication packets up to the sequence number of “2” of the flow ID “a” have been received, and the communication packet with the sequence number of “1” of the flow ID “b” has been received.

The communication node 42 receives a delivery confirmation packet for the communication packet with the sequence number “1” of the flow ID “b” from the destination node 43, and upon receiving the delivery confirmation information, the communication node 42 specifies the loss of the communication packet with the sequence number “3” of the flow ID “a”. That is, in the second to fourth embodiments, the loss of the communication packet with the sequence number “3” of flow ID “a” can only be specified at the timing when a delivery confirmation packet for the communication packet with the sequence number “6” of flow ID “a” is received from the destination node 43. On the other hand, in this embodiment, it is possible to specify the loss of the communication packet with the sequence number “3” of the flow ID “a” at the timing of receiving the delivery confirmation packet for the communication packet with the sequence number “1” of the flow ID “b” from the destination node 43.

The above-described fifth embodiment provides following operational effects.

In a configuration in which the destination node 43 transmits the delivery confirmation packets with thinning out data in the delivery confirmation packets during a period for receiving the communication packets having the same communication flow and the consecutive sequence numbers, the communication node 42 can provide the same effect as in the first embodiment, and it is possible to appropriately specify the occurrence of the packet loss while restricting the load related to the preprocessing for specifying the occurrence of the packet loss.

The present disclosure includes the following aspects of the embodiments.

### Feature [1]

A communication device transmits a communication packet to a destination device via a plurality of routes and receives a delivery confirmation packet with respect to the communication packet from the destination device. The communication device includes: at least one of (i) a circuit and (ii) a processor having a memory storing computer program code. The at least one of the circuit and the processor having the memory is configured to cause the communication device to provide: a sequence information acquisition unit that acquires sequence information of the communication packet of a communication flow; a transmission order correspondence information storage unit that stores a correspondence relationship between a transmission order of the communication packet and the sequence information of the communication packet acquired by the sequence information acquisition unit for each route as transmission order correspondence information; a delivery confirmation information acquisition unit that acquires delivery confirmation information indicating a delivery state of the communication packet; and a packet loss determination unit that determines whether a packet loss has occurred based on the transmission order correspondence information stored in the transmission order correspondence information storage unit and the delivery confirmation information acquired by the delivery confirmation information acquisition unit.

### Feature [2]

In the communication device according to the feature [1], the transmission order correspondence information storage unit stores, for each route, a correspondence relationship between the transmission order of the communication packet, flow identification information that identifies the communication flow, and the sequence information of the communication packet acquired by the sequence information acquisition unit as the transmission order correspondence information.

### Feature [3]

In the communication device according to the feature [1], the communication device functions as a relay device that transmits the communication packet received from a transmission device to the destination device, and the communication device further includes a confirmation information reconstruction unit that reconstructs the delivery confirmation information acquired by the delivery confirmation information acquisition unit when the packet loss determination unit determines that the packet loss has occurred, and transmits a reconstructed delivery confirmation information to the transmission device.

### Feature [4]

In the communication device according to the feature [1], the communication device functions as a relay device that transmits the communication packet received from a transmission device to the destination device, and the communication device further includes a packet retransmission unit that retransmits the communication packet in which the packet loss has been specified to the destination device when the packet loss determination unit determines that the packet loss has occurred.

### Feature [5]

In the communication device according to any one of the features [1] to [4], the communication device further includes a packet generation unit that generates a packet, and the sequence information acquisition unit acquires the sequence information of the communication packet generated by the packet generation unit.

### Feature [6]

In the communication device according to any one of the features [1] to [5], the communication device further includes a packet reception unit that receives the communication packet from an outside device, and the sequence information acquisition unit acquires the sequence information of the communication packet received by the packet reception unit from the outside device.

### OTHER EMBODIMENTS

Although the present disclosure has been made in accordance with the embodiments, it is understood that the present disclosure is not limited to such embodiments and structures. The present disclosure also includes various modification examples and modifications within an equivalent range. Various combinations and configurations, as well as other combinations and configurations including more, less, or only a single element, are within the scope and spirit of the present disclosure.

In the present disclosure, the term “processor” may refer to a single hardware processor or several hardware processors that are configured to execute computer program code (i.e., one or more instructions of a program). In other words, a processor may be one or more programmable hardware devices. For instance, a processor may be a general-purpose or embedded processor and include, but not necessarily limited to, CPU (a Central Processing Circuit), a microprocessor, a microcontroller, and PLD (a Programmable Logic Device) such as FPGA (a Field Programmable Gate Array).

The term “memory” in the present disclosure may refer to a single or several hardware memory configured to store computer program code (i.e., one or more instructions of a program) and/or data accessible by a processor. A memory may be implemented using any suitable memory technology, such as static random-access memory (SRAM), synchronous dynamic RAM (SDRAM), nonvolatile/Flash-type memory, or any other type of memory. Computer program code may be stored on the memory and, when executed by a processor, cause the processor to perform the above-described various functions.

In the present disclosure, the term “circuit” may refer to a single hardware logical circuit or several hardware logical circuits (in other words, “circuitry”) that are configured to perform one or more functions. In other words (and in contrast to the term “processor”), the term “circuit” refers to one or more non-programmable circuits. For instance, a circuit may be IC (an Integrated Circuit) such as ASIC (an application-specific integrated circuit) and any other types of non-programmable circuits.

In the present disclosure, the phrase “at least one of (i) a circuit and (ii) a processor” should be understood as disjunctive (logical disjunction) where the circuit and the processor can be optional and not be construed to mean “at least one of a circuit and at least one of a processor”. Therefore, in the present disclosure, the phrase “at least one of a circuit and a processor is configured to cause a communication system to perform functions” should be understood that (i) only the circuit can cause a communication system to perform all the functions, (ii) only the processor can cause a communication system to perform all the functions, or (iii) the circuit can cause a communication system to perform at least one of the functions and the processor can cause a communication system to perform the remaining functions. For instance, in the case of the above-described (iii), function A and B among the functions A to C may be implemented by a circuit, while the remaining function C may be implemented by a processor.

It is noted that a flowchart or the processing of the flowchart in the present application includes sections (also referred to as steps), each of which is represented, for instance, as S1. Further, each section can be divided into several sub-sections while several sections can be combined into a single section. Furthermore, each of thus configured sections can be also referred to as a device, module, or means.

What is claimed is:

1. A communication device for transmitting a communication packet to a destination device via a plurality of routes and receiving a delivery confirmation packet with respect to the communication packet from the destination device, the communication device comprising:
a sequence information acquisition unit that acquires sequence information of the communication packet for a communication flow;
a transmission order correspondence information storage unit that stores a correspondence relationship between a transmission order of the communication packet and the sequence information of the communication packet acquired by the sequence information acquisition unit for each route as transmission order correspondence information;
a delivery confirmation information acquisition unit that acquires delivery confirmation information indicating a delivery state of the communication packet; and
a packet loss determination unit that determines whether a packet loss has occurred based on the transmission order correspondence information stored in the transmission order correspondence information storage unit and the delivery confirmation information acquired by the delivery confirmation information acquisition unit.

2. The communication device according to claim 1, wherein:
the transmission order correspondence information storage unit stores a correspondence relationship between the transmission order of the communication packet, flow identification information that identifies the communication flow, and the sequence information of the communication packet acquired by the sequence information acquisition unit for each route as the transmission order correspondence information.

3. The communication device according to claim 1, wherein:
the communication device functions as a relay device that transmits the communication packet received from a transmission device to the destination device,
the communication device further comprising a confirmation information reconstruction unit that reconstructs the delivery confirmation information acquired by the delivery confirmation information acquisition unit when the packet loss determination unit determines that the packet loss has occurred, and transmits a reconstructed delivery confirmation information to the transmission device.

4. The communication device according to claim 1, wherein:
the communication device functions as a relay device that transmits the communication packet received from a transmission device to the destination device,
the communication device further comprising a packet retransmission unit that retransmits the communication packet in which the packet loss has been specified to the destination device when the packet loss determination unit determines that the packet loss has occurred.

5. The communication device according to claim 1, further comprising:
a packet generation unit that generates the communication packet, wherein:
the sequence information acquisition unit acquires the sequence information of the communication packet generated by the packet generation unit.

6. The communication device according to claim 1, further comprising:
a packet reception unit that receives the communication packet from an outside device, wherein:
the sequence information acquisition unit acquires the sequence information of the communication packet received by the packet reception unit from the outside device.

7. The communication device according to claim 1, further comprising:
at least one of (i) a circuit and (ii) a processor having a memory storing computer program code, wherein:
the at least one of the circuit and the processor having the memory is configured to cause the communication device to provide at least one of: the sequence information acquisition unit; the transmission order correspondence information storage unit; the delivery confirmation information acquisition unit; and the packet loss determination unit.

8. A communication system comprising:
a communication device that transmits a communication packet to a destination device via a plurality of routes; and
a destination device that transmits a delivery confirmation packet of the communication packet to the communication device, wherein:
the communication device includes:
a sequence information acquisition unit that acquires sequence information of the communication packet for a plurality of communication flows;
a transmission order correspondence information storage unit that stores, for each route, a correspondence relationship between a transmission order of the communication packet, flow identification information that identifies the communication flows, and the sequence information of the communication packet acquired by the sequence information acquisition unit as transmission order correspondence information,
a delivery confirmation information acquisition unit that acquires delivery confirmation information indicating a delivery state of the communication packet; and
a packet loss determination unit that determines whether a packet loss has occurred based on the transmission order correspondence information stored in the transmission order correspondence information storage unit and the delivery confirmation information acquired by the delivery confirmation information acquisition unit;
the destination device transmits the delivery confirmation packet with thinning out data of the delivery confirmation packet during a period in which the destination device receives the communication packet having a same communication flow and consecutive sequence information.

9. The communication system according to claim 8, further comprising:
at least one of (i) a circuit and (ii) a processor having a memory storing computer program code, wherein:
the at least one of the circuit and the processor having the memory is configured to cause the communication system to provide at least one of: the communication device; and the destination device.

10. A method for specifying a packet loss in a communication device for transmitting a communication packet to a destination device via a plurality of routes and receiving a delivery confirmation packet with respect to the communication packet from the destination device, the method for specifying the packet loss comprising:
a sequence information acquisition procedure for acquiring sequence information of the communication packet for a communication flow;
a transmission order correspondence information storage procedure for storing a correspondence relationship between a transmission order of the communication packet and the sequence information of the communication packet acquired in the sequence information acquisition procedure for each route as transmission order correspondence information;
a delivery confirmation information acquisition procedure for acquiring delivery confirmation information indicating a delivery state of the communication packet; and
a packet loss determination procedure for determining whether the packet loss has occurred based on the transmission order correspondence information stored in the transmission order correspondence information storage procedure and the delivery confirmation information acquired in the delivery confirmation information acquisition procedure.

11. A non-transitory computer readable storage medium comprising instructions being executed by a computer, the instructions including a computer-implemented method for specifying a packet loss in a communication device for transmitting a communication packet to a destination device via a plurality of routes and receiving a delivery confirmation packet with respect to the communication packet from the destination device, the instructions including:
a sequence information acquisition procedure for acquiring sequence information of the communication packet for a communication flow;
a transmission order correspondence information storage procedure for storing a correspondence relationship between a transmission order of the communication packet and the sequence information of the communication packet acquired in the sequence information acquisition procedure for each route as transmission order correspondence information;
a delivery confirmation information acquisition procedure for acquiring delivery confirmation information indicating a delivery state of the communication packet; and
a packet loss determination procedure for determining whether the packet loss has occurred based on the transmission order correspondence information stored in the transmission order correspondence information storage procedure and the delivery confirmation information acquired in the delivery confirmation information acquisition procedure.
